(19) United States
(12) Patent Application Publication
(10) Pub. No.: US 2026/0071953 A1
(43) Pub. Date: Mar. 12, 2026

(54) METHODS AND APPARATUS FOR TESTING OPTICAL PERFORMANCE OF THIN, FLEXIBLE PIEZOELECTRIC-ACTIVATED ELECTROPHORETIC DISPLAYS

(71) Applicant: E Ink Corporation, Billerica, MA (US)

(72) Inventors: Haiyan GU, Fremont, CA (US); Hanan LIU, Milpitas, CA (US); Efrain VELAZQUEZ, Mountain House, CA (US); Craig LIN, Fremont, CA (US); Yuriy Borisovich MATUS, Pleasanton, CA (US); Setareh NIKNEZHAD, San Jose, CA (US)

(21) Appl. No.: 19/305,139

(22) Filed: Aug. 20, 2025

Related U.S. Application Data
(60) Provisional application No. 63/692,394, filed on Sep. 9, 2024.

(51) Int. Cl. G01N 21/25; G01N 21/27

(52) U.S. Cl. CPC G01N 21/255; G01N 21/251; G01N 21/27

(57) ABSTRACT

Methods and systems are disclosed for testing optical states of a piezoelectric-activated electrophoretic display sample. The sample includes an electrophoretic layer superposed on and electrically connected to a piezoelectric layer. The electrophoretic layer changes optical states when the sample is manipulated between flat and bent positions. The system includes a bending apparatus for adjustably holding and manipulating the sample between the flat and bent positions to mimic hand manipulation of the sample in a plurality of bending cycles. The system also includes a color sensor operating cooperatively with the bending apparatus to detect the optical state of a given portion of the electrophoretic layer of the sample in the flat and bent positions in each bending cycle. The system further includes a control system for synchronizing the operations of the bending apparatus and the color sensor and for recording the optical states detected by the color sensor.

### CROSS REFERENCE TO RELATED APPLICATION(S)

This application claims priority from U.S. Provisional Patent Application No. 63/692,394 filed on Sep. 9, 2024 entitled METHODS AND APPARATUS FOR TESTING OPTICAL PERFORMANCE OF THIN, FLEXIBLE PIEZOELECTRIC-ACTIVATED ELECTROPHORETIC DISPLAYS, which is hereby incorporated by reference in its entirety.

### BACKGROUND

The present application generally relates to flexible, low-profile piezo-electrophoretic displays and, more particularly, to methods and apparatus for testing the optical performance of such displays.

Non-emissive displays convey information using contrast differences, which are achieved by varying the reflectance of different frequencies of light. They are distinct from traditional emissive displays, which stimulate the eye by emitting light. One type of non-emissive display is an electrophoretic display or “EPD,” which utilizes the phenomenon of electrophoresis to achieve contrast. Electrophoresis refers to movement of charged pigment particles in an applied electric field. When electrophoresis occurs in a liquid, the particles move with a velocity determined primarily by the viscous drag experienced by the pigment particles, their charge, the dielectric properties of the liquid, and the magnitude of the applied electric field.

One type of electrophoretic display utilizes charged pigment particles of one color suspended in a dielectric liquid medium of a different color (that is, light reflected by the particles is absorbed by the liquid). The suspension is housed in a cell located between (or partly defined by) a pair of oppositely-disposed electrodes, one of which is typically transparent. When the electrodes are operated to apply a DC or pulsed field across the medium, the pigment particles migrate toward the electrode having the opposite polarity of the charged pigment particles. The result is a visually observable color change. In particular, when a sufficient number of the particles reach the transparent electrode, the color of the pigment particles is seen from the viewing side of the display. Alternatively, if the particles are drawn to the other electrode, the color of the liquid medium dominates the viewing side of the display instead.

Many electrophoretic displays incorporate an electrophoretic fluid that includes a non-polar solvent and two or more sets of charged pigment particles. The particles can have different optical properties (colors), different charges (positive or negative), different charge magnitudes (zeta potentials), and/or different absorptive properties (broadly light-absorbing or broadly light-reflecting, or selectively-absorbing or selectively reflecting). In the instance where there are multiple particle sets with opposite charge polarities, application of an electric field may cause a pigment particle of one set to appear at the viewing surface while the other pigment particle is driven away from the viewing surface.

Many electrophoretic displays are bi-stable meaning the optical state of such displays persists even after the activating electric field is removed. Bistability is primarily a result of induced dipole charge layers forming around the charged pigments due to complex interactions between the pigments, charge control agents, and free polymers dispersed in the solvent. A bistable display can last for years in the last-addressed optical state before being switched again with the application of a new driving field.

Driving an electrophoretic display requires a power source such as a battery to provide power to the display and/or its driving circuitry. For example, a battery may be used to supply power to a driver integrated circuit (IC) that in turn generates an electric field to energize the display's electrodes. The power source could also be, e.g., a photovoltaic cell, a fuel cell, or a power supply that receives power from a wall outlet. In addition, the power supply could be a piezo-electric element, which creates charge through physical motion or thermal expansion, as described, e.g., in U.S. Pat. No. 5,930,026, which is incorporated by reference in its entirety. In all of these examples, some type of driving circuitry is used to provide an electrical pathway between the power source and the electrodes and typically, the circuitry includes control elements such as switches, transistors, etc. In most instances, the circuitry is fairly routine, however it typically adds bulk and structural limitations (i.e., not flexible or twistable) to the final display. U.S. Patent Application Publication No. 2023/0273495, which is incorporated by reference in its entirety, discloses flexible, durable, low-profile piezoelectric-driven electrophoretic displays for use as security markers, sensors, and indicators. A need exists for a method and apparatus for testing the optical states generated by such flexible, low-profile piezoelectric-driven electrophoretic displays.

### SUMMARY

In accordance with a first aspect of the invention, a system is disclosed for testing the optical states of a piezoelectric-activated electrophoretic display sample. The display sample comprises an electrophoretic layer superposed on and electrically connected to a piezoelectric layer. The electrophoretic layer is configured to change optical states when the display sample including the piezoelectric layer is manipulated between flat and bent positions to cause the piezoelectric layer to generate an electrical output applied to the electrophoretic layer. The testing system includes a bending apparatus for holding and manipulating the display sample between the flat and bent positions to mimic hand manipulation of the display sample in a plurality of bending cycles. The testing system also includes a color sensor operating cooperatively with the bending apparatus to detect the optical state of a given portion of the electrophoretic layer of the display sample in the flat and bent positions in each bending cycle. The system further includes a control system, including at least one processor, coupled to the bending apparatus and the color sensor for synchronizing operation of the bending apparatus and the color sensor and for recording the optical states detected by the color sensor.

In one or more embodiments, the color sensor comprises a colorimeter, a spectrophotometer, a photoelectric detector, a charge-coupled device (CCD) camera, or a photodiode.

In one or more embodiments, the bending apparatus comprises a cylinder on which the display sample is held, a fork comprising two prongs positioned in parallel to the cylinder on opposite sides of the cylinder and on an opposite side of the display sample from the cylinder, and a mechanism for moving the cylinder or the fork relative to each other such that the cylinder forms a fulcrum about which the display sample is bent.

In one or more embodiments, the mechanism for moving the cylinder or the fork comprises a linear actuator.

In one or more embodiments, the cylinder is stationary and the fork is moved by the linear actuator.

In one or more embodiments, the linear actuator can be configured to adjust the speed and/or travel distance of the fork.

In one or more embodiments, the mechanism for moving the cylinder or the fork is operable at an adjustable speed.

In one or more embodiments, the linear actuator includes a stepper motor.

In one or more embodiments, the cylinder has a diameter of about 4 mm to 12 mm.

In one or more embodiments, the cylinder is removable from the bending apparatus and is replaceable by another cylinder having a different diameter to adjust a bending curvature of the display sample.

In one or more embodiments, the cylinder or the fork are moved relative to each other at a speed of 15 cm/sec or less.

In one or more embodiments, the control system includes a single-axis motion controller for controlling operation of the linear actuator.

In one or more embodiments, the control system analyzes the optical states detected by the color sensor to quantify optical contrast between the optical states detected at the flat and bent positions in each bending cycle.

In accordance with another aspect of the invention, a method is disclosed for testing the optical states of a piezoelectric-activated electrophoretic display sample. The method comprises (a) manipulating the display sample between the flat and bent positions using a bending apparatus to mimic hand manipulation of the display sample in a plurality of bending cycles; (b) detecting the optical state of a given portion of the electrophoretic layer of the display sample when in the flat and bent positions in each bending cycle using a color sensor; and (c) recording the optical states detected by the color sensor.

In one or more embodiments, the method further comprises analyzing the optical states detected by the color sensor to quantify optical contrast between the optical states detected at the flat and bent positions in each bending cycle.

### BRIEF DESCRIPTION OF DRAWINGS

FIG. 1 is a schematic cross sectional view of an exemplary piezo-electrophoretic display in accordance with the subject matter disclosed herein.

FIG. 2 shows an exemplary system for testing the optical states of low-profile, flexible piezoelectric-activated displays in accordance with a first aspect of the invention.

FIG. 3 shows a portion of the bending apparatus of the testing system in accordance with one or more embodiments.

FIG. 4 shows cylinders having different sizes usable in the bending apparatus in accordance with one or more embodiments.

FIG. 5 shows additional details of the bending apparatus in accordance with one or more embodiments.

FIGS. 6A and 6B are simplified cross-sectional views showing bending of a display sample using the bending apparatus.

FIG. 7 is a flow chart illustrating an exemplary process for testing the optical states of low-profile, flexible piezoelectric-activated displays in accordance with another aspect of the invention.

### DETAILED DESCRIPTION

Methods and apparatus for testing the optical performance of flexible, low-profile piezo-electrophoretic display films are disclosed herein.

The term “electro-optic,” as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

The term “gray state” is used herein in its conventional meaning in the imaging art to refer to a state intermediate two extreme optical states of a pixel, and does not necessarily imply a black-white transition between these two extreme states. For example, several of the E Ink patents and published applications referred to below describe electrophoretic displays in which the extreme states are white and deep blue, so that an intermediate “gray state” would actually be pale blue. Indeed, as already mentioned, the change in optical state may not be a color change at all. The terms “black” and “white” may be used hereinafter to refer to the two extreme optical states of a display, and should be understood as normally including extreme optical states which are not strictly black and white, for example, the aforementioned white and dark blue states. The term “monochrome” may be used hereinafter to denote a display or drive scheme which only drives pixels to their two extreme optical states with no intervening gray states.

The term “pixel” is used herein in its conventional meaning in the display art to mean the smallest unit of a display capable of generating all the colors which the display itself can show. In a full color display, typically each pixel is composed of a plurality of sub-pixels each of which can display less than all the colors which the display itself can show. For example, in most conventional full color displays, each pixel is composed of a red sub-pixel, a green sub-pixel, a blue sub-pixel, and optionally a white sub-pixel, with each of the sub-pixels being capable of displaying a range of colors from black to the brightest version of its specified color.

Several types of electro-optic displays are known. One type of electro-optic display uses an electrochromic medium, for example an electrochromic medium in the form of a nanochromic film comprising an electrode formed at least in part from a semi-conducting metal oxide and a plurality of dye molecules capable of reversible color change attached to the electrode; see, for example O'Regan, B., et al., Nature 1991, 353, 737; and Wood, D., Information Display, 18(3), 24 (March 2002). See also Bach, U., et al., Adv. Mater., 2002, 14(11), 845. Nanochromic films of this type are also described, for example, in U.S. Pat. Nos. 6,301,038; 6,870,657; and 6,950,220. This type of medium is also typically bistable.

Another type of electro-optic display is an electro-wetting display developed by Philips and described in Hayes, R. A., et al., “Video-Speed Electronic Paper Based on Electrowetting”, Nature, 425, 383-385 (2003). It is shown in U.S. Pat. No. 7,420,549 that such electro-wetting displays can be made bistable.

One type of electro-optic display, which has been the subject of intense research and development for a number of years, is the particle-based electrophoretic display, in which a plurality of charged particles move through a fluid under the influence of an electric field. Electrophoretic displays can have attributes of good brightness and contrast, wide viewing angles, state bistability, and low power consumption when compared with liquid crystal displays.

An electrophoretic display normally comprises a layer of electrophoretic material and at least two other layers disposed on opposed sides of the electrophoretic material, at least one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode and the other electrode layer is patterned into a matrix of pixel electrodes, each of which defines one pixel of the display. In another type of electrophoretic display, which is intended for use with a stylus, print head or similar movable electrode separate from the display, only one of the layers adjacent the electrophoretic layer comprises an electrode, the layer on the opposed side of the electrophoretic layer typically being a protective layer intended to prevent the movable electrode damaging the electrophoretic layer.

Numerous patents and applications assigned to or in the names of the Massachusetts Institute of Technology (MIT) and E Ink Corporation describe various technologies used in encapsulated electrophoretic and other electro-optic media. Such encapsulated media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. The technologies described in these patents and applications include:
(a) Electrophoretic particles, fluids and fluid additives; see for example U.S. Pat. Nos. 7,002,728 and 7,679,814;
(b) Capsules, binders and encapsulation processes; see for example U.S. Pat. Nos. 6,922,276 and 7,411,719;
(c) Films and sub-assemblies containing electro-optic materials; see for example U.S. Pat. Nos. 6,982,178 and 7,839,564;
(d) Backplanes, adhesive layers and other auxiliary layers and methods used in displays; see for example U.S. Pat. Nos. 7,116,318 and 7,535,624;
(e) Color formation and color adjustment; see for example U.S. Pat. Nos. 7,075,502 and 7,839,564;
(f) Methods for driving displays; see for example U.S. Pat. Nos. 7,012,600 and 7,453,445;
(g) Applications of displays; see for example U.S. Pat. Nos. 7,312,784 and 8,009,348;
(h) Non-electrophoretic displays, as described in U.S. Pat. Nos. 6,241,921; 6,950,220; 7,420,549 and 8,319,759; and U.S. Patent Application Publication No. 2012/0293858;
(i) Microcell structures, wall materials, and methods of forming microcells; see for example U.S. Pat. Nos. 7,072,095 and 9,279,906; and
(j) Methods for filling and sealing microcells; see for example U.S. Pat. Nos. 7,144,942 and 7,715,088.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

A related type of electrophoretic display is a so-called “microcell electrophoretic display,” also known as MICROCUP®. In a microcell electrophoretic display, the charged particles and the fluid are not encapsulated within microcapsules but instead are retained within a plurality of cavities formed within a carrier medium, typically a polymeric film. See, e.g., U.S. Pat. Nos. 6,672,921 and 6,788,449, both of which are incorporated herein by reference in their entireties.

Although electrophoretic media are often opaque (since, e.g., in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, e.g., U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode may be useful in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed, using a variety of methods, the display itself can be made inexpensively.

The aforementioned U.S. Pat. No. 6,982,178 describes a method of assembling a solid electro-optic display (including an encapsulated electrophoretic display), which is well adapted for mass production. Essentially, this patent describes a so-called “front plane laminate” (“FPL”), which comprises, in order, a light-transmissive electrically-conductive layer; a layer of a solid electro-optic medium in electrical contact with the electrically-conductive layer; an adhesive layer; and a release sheet. Typically, the light-transmissive electrically-conductive layer will be carried on a light-transmissive substrate, which is preferably flexible, in the sense that the substrate can be manually wrapped around a drum (say) 10 inches (254 mm) in diameter without permanent deformation. The term “light-transmissive” is used in this patent and herein to mean that the layer thus designated transmits sufficient light to enable an observer, looking through that layer, to observe the change in display states of the electro-optic medium, which will normally be viewed through the electrically-conductive layer and adjacent substrate (if present); in cases where the electro-optic medium displays a change in reflectivity at non-visible wavelengths, the term “light-transmissive” should of course be interpreted to refer to transmission of the relevant non-visible wavelengths. The substrate will typically be a polymeric film, and will normally have a thickness in the range of about 1 to about 25 mil (25 to 634 μm), preferably about 2 to about 10 mil (51 to 254 μm). The electrically-conductive layer is conveniently a thin metal or metal oxide layer of, for example, aluminum or ITO, or may be a conductive polymer. Poly (ethylene terephthalate) (PET) films coated with aluminum or ITO are available commercially, for example as “aluminized Mylar” (“Mylar” is a Registered Trade Mark) from E.I. du Pont de Nemours & Company, Wilmington DE, and such commercial materials may be used with good results in the front plane laminate.

Assembly of an electro-optic display using such a front plane laminate may be effected by removing the release sheet from the front plane laminate and contacting the adhesive layer with the backplane under conditions effective to cause the adhesive layer to adhere to the backplane, thereby securing the adhesive layer, layer of electro-optic medium and electrically-conductive layer to the backplane. This process is well-adapted to mass production since the front plane laminate may be mass produced, typically using roll-to-roll coating techniques, and then cut into pieces of any size needed for use with specific backplanes.

U.S. Pat. No. 7,561,324 describes a so-called “double release sheet” which is essentially a simplified version of the front plane laminate of the aforementioned U.S. Pat. No. 6,982,178. One form of the double release sheet comprises a layer of a solid electro-optic medium sandwiched between two adhesive layers, one or both of the adhesive layers being covered by a release sheet. Another form of the double release sheet comprises a layer of a solid electro-optic medium sandwiched between two release sheets. Both forms of the double release film are intended for use in a process generally similar to the process for assembling an electro-optic display from a front plane laminate already described, but involving two separate laminations. Typically, in a first lamination the double release sheet is laminated to a front electrode to form a front sub-assembly, and then in a second lamination the front sub-assembly is laminated to a backplane to form the final display, although the order of these two laminations could be reversed if desired.

The subject matter presented herein relates to flexible, low-profile piezo-electrophoretic displays, which do not need a power supply (e.g., battery, wired power supply, photovoltaic source, etc.) in order for the display to operate.

Piezoelectricity is the charge that accumulates in a solid material in response to applied mechanical stress. Suitable materials for the subject matter disclosed herein include polyvinylidene fluoride (PVDF), quartz (SiO₂), berlinite (AlPO₄), gallium orthophosphate (GaPO₄), tourmaline, barium titanate (BaTiO₃), lead zirconate titanate (PZT), zinc oxide (ZnO), aluminum nitride (AlN), lithium tantalite, lanthanum gallium silicate, potassium sodium tartrate and any other known piezoelectric materials.

Piezo-electrophoretic displays use piezoelectricity to drive the charged pigment particles of an electrophoretic medium toward one of the display electrodes. Thus, manipulating or physically straining the piezoelectric material when coupled to an electrophoretic media layer can cause the color of the electrophoretic material at the viewing surface to change. For example, by bending or introducing other mechanical stress to a piece of piezoelectric material, voltage may be generated across the electrophoretic medium and this voltage can be utilized to cause movement of the color pigment particles of the electrophoretic medium. If only portions of an electrophoretic media layer are coupled to a piezoelectric material, an electrophoretic medium having two types of oppositely-charged pigments can be used to create patterns with high contrast ratios. As used herein, the term “contrast ratio” or “CR” for an electro-optic display (e.g., an electrophoretic display) is defined as the ratio of the luminance of the brightest color (white) to that of the darkest color (black) that the display is capable of producing. Normally, a high contrast ratio is a desired aspect of an electro-optic display.

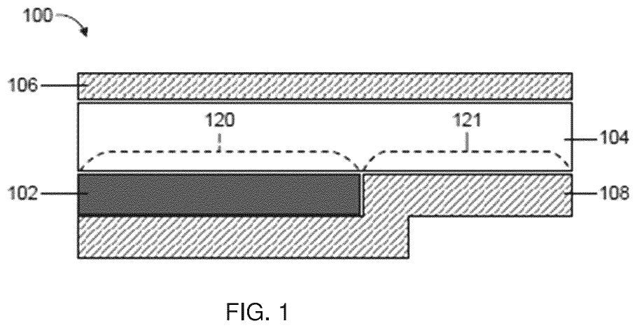

FIG. 1 is a cross sectional view of one example of a piezo-electrophoretic display 100, which uses a piezoelectric material 102 to generate a voltage potential sufficient to drive charged pigment particles within a layer of electrophoretic material 104. Display 100 includes a first electrode 106 overlapping or covering a first surface of the layer of electrophoretic material 104. Display 100 further includes piezoelectric material 102 overlapping or covering a first portion of a second surface of the layer of electrophoretic material 104, as denoted by surface area 120 in FIG. 1. A second electrode 108 overlaps with all of the piezoelectric material 102 and a second portion of the second surface of the layer of electrophoretic material 104, as denoted by surface area 121 in FIG. 1.

The piezoelectric material 102 can be a piezoelectric film that is coupled to surface area 120 of the layer of electrophoretic material 104 using a lamination process. In some embodiments, the piezoelectric material 102 is formed by depositing a piezoelectric material onto the layer of electrophoretic material 104. For example, the surface area 120 of the layer of electrophoretic material 104 can be coated with a thin film of piezoelectric material, such as PVDF, using a spin-coating process or casting (e.g., slot-dye coating). A film deposition process such as printing, spraying, or gravure coating can be used to form the piezoelectric material 102 on the layer of electrophoretic material 104. The resulting piezoelectric material 102 can be less than 10 μm in thickness, e.g., about 3 μm in thickness.

The electrode 108 overlaps with or covers the piezoelectric material 102 and surface area 121 of the layer of electrophoretic material 104. The electrode 108 can be a conductive adhesive material (e.g., copper tape) that is applied over the piezoelectric material 102 and surface area 121 of the layer of electrophoretic material 104. The electrode 108 can be a metal film, such as a copper, silver, gold, or aluminum film or foil that is bonded to a flexible, light-transmissive substrate (not shown) such as a polymeric film. The electrode 108 can comprise a transparent conductive material (e.g., a first electrically-conductive adhesive) including a conductive metal oxide, conductive polymer, and/or other suitable conductive agent that is coated onto a substrate (not shown). For example, a thin layer of electrically-conductive material (e.g., ITO) can be directly-deposited (e.g., sputtered, vapor deposited) onto a suitable substrate, such as a polymer substrate (e.g., PET). The electrode 108 can be less than 5 μm in thickness, e.g., about 1-3 μm in thickness. In some cases, the electrode 108 is less than 1 μm in thickness.

The first electrode 106 is bonded to the layer of electrophoretic material 104 on a surface opposite to the piezoelectric material 102 and electrode 108. For example, the electrode 106 can be laminated to the layer of electrophoretic material 104 to form a microcapsule-or microcell-based front plane laminate or FPL as described above in connection with U.S. Pat. No. 6,982,178.

The electrode 106 can be formed in advance on a substrate (not shown) using one of the processes described above with respect to the electrode 108. The electrode 106 can comprise a transparent conductive material (e.g., a first electrically-conductive adhesive) including a conductive metal oxide, conductive polymer, and/or other suitable conductive agent that is coated onto a substrate (not shown). For example, a thin layer of electrically-conductive material (e.g., ITO) can be directly-deposited (e.g., sputtered, vapor deposited) onto a suitable substrate, such as a polymer substrate (e.g., PET). The substrate can be a release sheet used temporarily to facilitate fabrication of the piezo-electrophoretic film.

The electrode 106 can be less than 5 μm in thickness, e.g., about 1-3 μm in thickness.

The layer of electrophoretic material 104 can fabricated onto the electrode 106 before being bonded with the piezoelectric material 102 and electrode 108. For example, electrode 106 can be coated with an electrophoretic medium layer including a plurality of microcapsules containing a non-polar fluid and charged pigment particles (not shown in FIG. 1). Alternatively, an electrophoretic medium layer comprising a plurality of microcell structures can be formed on the electrode 106. For example, an embossable microcell precursor material can be laminated to the electrode 106. Prior to lamination, the precursor material may be treated or coated with a microcell primer comprising, e.g., acrylates, vinyl ethers, or epoxides, as described in detail, for example, in U.S. Pat. Nos. 6,930,818, 7,052,571, 7,616,374, 8,361,356, and 8,830,561, all of which are incorporated by reference in their entireties. The microcell precursor is microembossed or photolithographed, resulting in an open microcell structure that is subsequently filled with the desired electrophoretic medium and sealed with a sealing layer. The open microcells may optionally be cleaned/activated with a vapor plasma treatment before the microcells are filled with the desired electrophoretic medium. The layer of electrophoretic material 104 can be between 10 and 30 μm in thickness, e.g., about 15 μm in thickness.

### Method and Apparatus for Optical Testing of Piezo-Electrophoretic Displays

Various embodiments disclosed herein relate to methods and apparatus for testing the optical states of low-profile, flexible piezoelectric-activated displays such as, e.g., the display 100 depicted in FIG. 1. As noted above, applications of such displays include use as security markers (e.g., for anti-counterfeit purposes), sensors, and indicators. A need exists for an effective, reliable system for repeatedly applying bending stress to flexible piezoelectric-activated displays and testing the resulting optical performance of such displays.

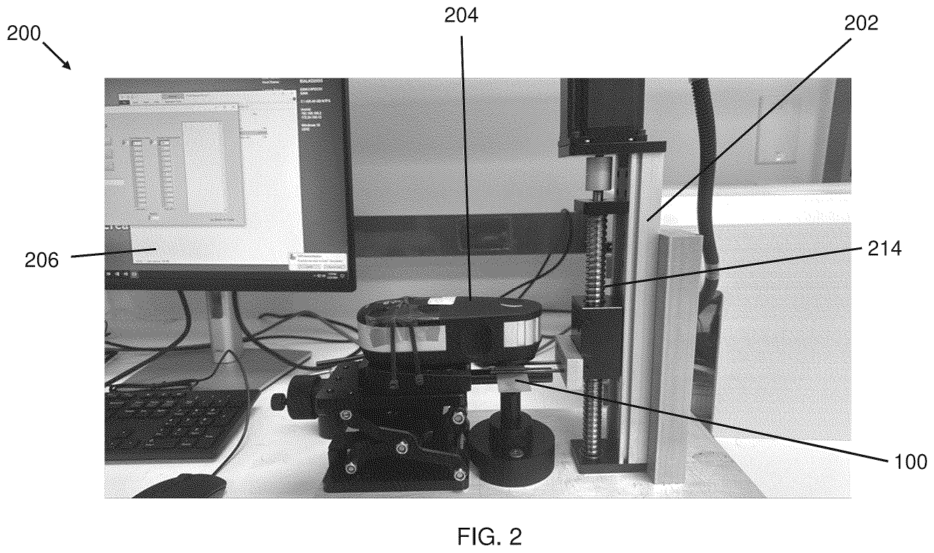

FIGS. 2-5 illustrate an exemplary system 200 for testing the optical states of low-profile, flexible piezoelectric-activated displays. As noted above, low-profile, flexible piezoelectric-activated displays comprise an electrophoretic layer superposed on and electrically connected to a piezoelectric layer. When the display is manipulated between flat and bent positions, the piezoelectric layer is stressed and generates an electrical output, which is applied to the electrophoretic layer causing it to change optical states. The testing system 200 tests and records the optical states of the display 100 in the flat and bent positions. The system 200 can use the optical measurements to, among other things, quantify the optical contrast between the optical states.

The testing system 200 includes a bending apparatus 202 for holding and repeatedly manipulating piezoelectric-activated display samples 100 between flat and bent positions. The bending apparatus 202 mimics hand manipulation of the display 100 through a series of bending cycles.

A color sensor 204 operates cooperatively with the bending apparatus 202 to detect the optical state of a given portion of the electrophoretic layer of a display sample 100. The operation of the color sensor 204 is synchronized with the operation of the bending apparatus 202 such that the sensor 204 detects the optical state of the sample in the same flat and bent positions in each of a plurality of bending cycles.

A control system (including at least one processor) 206 is coupled to the bending apparatus 202 and the color sensor 204. The control system 206 is programmed to synchronize bending of the sample 100 with detection of the resulting optical states. The control system 206 also records the detected optical states and quantifies optical contrast.

The color sensor 204 can comprise any device for capturing and evaluating color including, but not limited to, a colorimeter, a spectrophotometer, a photoelectric detector, a charge-coupled device (CCD) camera, or a photodiode. In one non-limiting example, the color sensor 204 comprises an i1™ spectrophotometer.

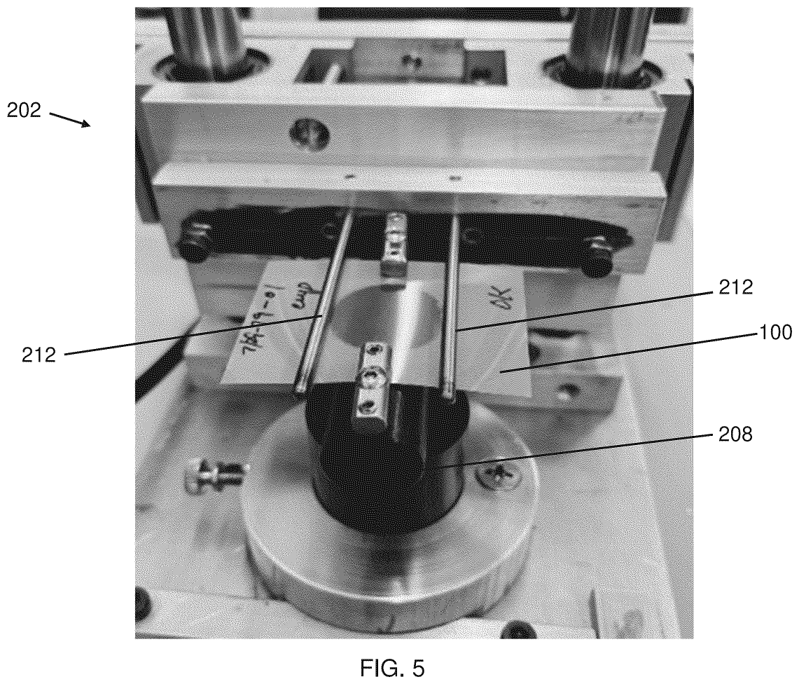

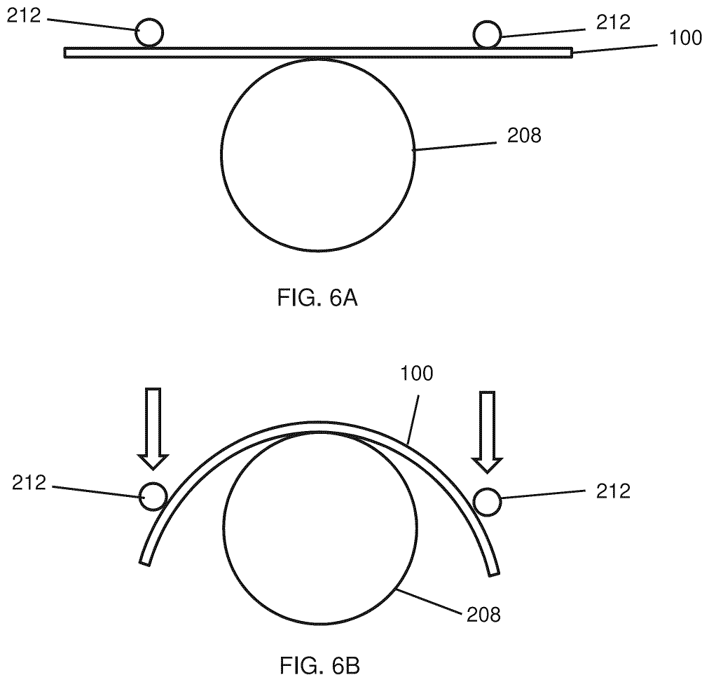

The bending apparatus 202 includes a cylinder 208 on which the display sample 100 is held and a fork 210 that is movable relative to the cylinder 208. The display sample 100 is held between the fork 210 and the cylinder 208 as depicted in FIGS. 5 and 6A-6B. The fork 210 comprises two prongs 212 positioned in parallel to the cylinder 208 on opposite sides of the cylinder 208 and on an opposite side of the sample 100 from the cylinder 208.

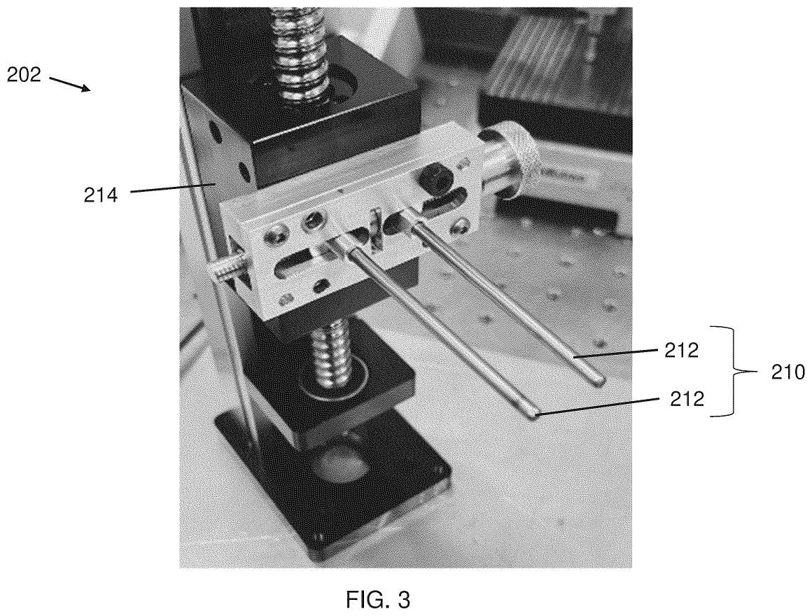

The bending apparatus 202 includes a linear actuator 214 (shown in FIGS. 2 and 3) for moving the fork 210 back and forth relative to the cylinder 208. The cylinder 208 thereby forms a fulcrum about which the display sample is bent as shown in FIGS. 6A and 6B. In the illustrated embodiment, the cylinder 208 is stationary and the fork 210 is moved by the linear actuator 214. In alternate embodiments, the fork 210 is stationary and the cylinder 208 is coupled to and moved by the linear actuator 214. In further alternate embodiments, both the fork 210 and the cylinder 208 are moved.

The linear actuator 214 may comprise a stepper motor and a leadscrew, which is operatively coupled to the fork 210. Rotational motion generated by the motor turns the leadscrew, which results in linear motion of the fork 210. The linear actuator 214 can be controlled by a single-axis motion controller (not shown). The linear actuator 214 can be configured to adjust the speed and/or travel distance of the fork 210. By way of example, the fork 210 travels at speeds up to 15 cm/sec.

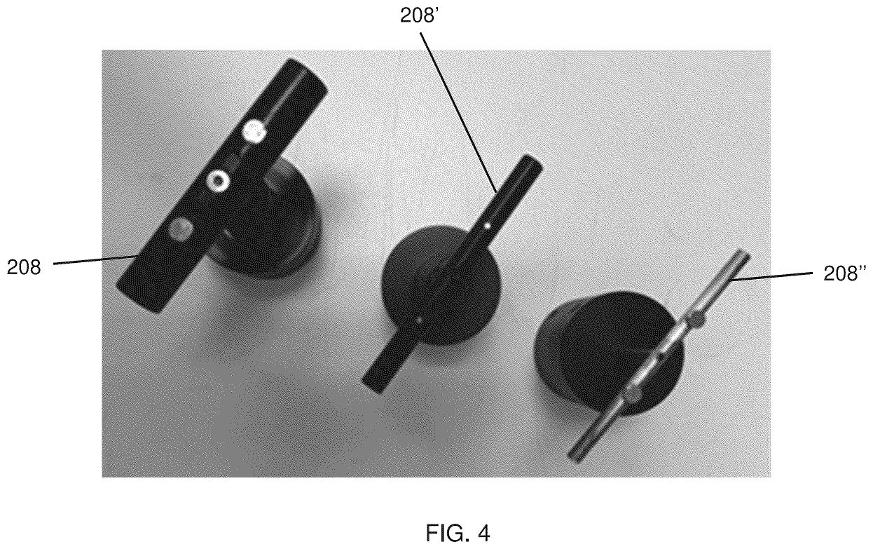

The cylinder 208 defines the bending curvature of the display sample as shown in FIG. 6B. Different bending curvatures result in different stresses applied to the piezoelectric layer of the sample. The cylinder 208 is removably attached in the bending apparatus 202 and is replaceable by another cylinder having a different diameter to adjust the bending curvature. FIG. 4 shows an example of three different cylinders 208, 208′, 208′″ that can be used in the testing apparatus. By way of example, the cylinder diameter can range from about 4 mm to 12 mm.

The control system 206 analyzes the optical states detected by the color sensor 204 to quantify optical contrast between the optical states detected at the flat and bent positions in each bending cycle. The control system 206 controls the speed of the stepper motor and the position of the fork 210 relative to the cylinder 208. The control system 206 is programmed to trigger optical measurements by the color sensor 204 when the fork 210 is at specified positions relative to the cylinder 208 corresponding to the flat and bent positions of the sample in each bending cycle. The control system 206 also records the optical measurements.

The processes of the control system 206 can be implemented in one or more computer programs executing on a programmable computer including at least one processor, a storage medium readable by the at least one processor (including, e.g., system memory or mass-storage memory), and input and output devices. One of ordinary skill in the art would also recognize that such processes may also be implemented in hardware, firmware, or more specialized apparatus.

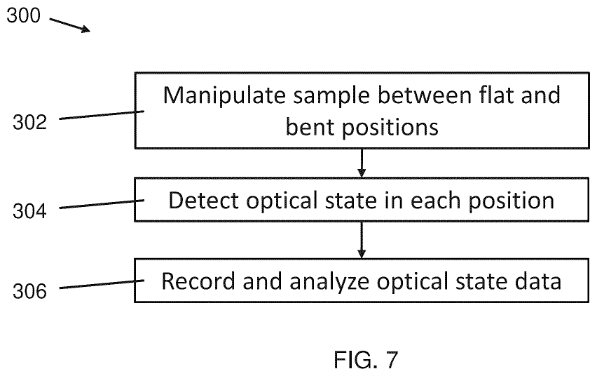

FIG. 7 is a flowchart showing an exemplary method 300 of testing the optical states of low-profile, flexible piezoelectric-activated displays in accordance with another aspect of the invention. At step 302, a display sample 100 is manipulated between the flat and bent positions using the bending apparatus 202 to mimic hand manipulation of the sample in a plurality of bending cycles. At step 304, the optical state of a given portion of the electrophoretic layer of the sample is detected using the color sensor 204 when the sample 100 is in the flat and bent positions in each bending cycle. At step 306, the optical states detected by the color sensor 204 are recorded and analyzed by a computer control system 206.

The testing system and method provide an effective way of testing the optical performance of low-profile, flexible piezoelectric-activated displays. It synchronizes sample bending with optical measurement for accurate and repeatable testing. The system 200 enables faster and smoother sample manipulation for good sample activation. In addition, the testing system 200 enables various parameters to be easily adjusted in order to vary the optical performance being tested. As noted above, the adjustable parameters include: (1) diameter of the sample holder cylinder 208 (to vary bending curvature of the sample), and (2) the fork speed and travel distance (to vary stress applied to the sample).

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

1. A system for testing optical states of a piezoelectric-activated electrophoretic display sample, the display sample comprising an electrophoretic layer superposed on and electrically connected to a piezoelectric layer, wherein the electrophoretic layer is configured to change optical states when the display sample including the piezoelectric layer is manipulated between flat and bent positions to cause the piezoelectric layer to generate an electrical output applied to the electrophoretic layer, the system comprising:
a bending apparatus for holding and manipulating the display sample between the flat and bent positions to mimic hand manipulation of the display sample in a plurality of bending cycles;
a color sensor operating cooperatively with the bending apparatus to detect the optical state of a given portion of the electrophoretic layer of the display sample in the flat and bent positions in each bending cycle; and
a control system, including at least one processor, coupled to the bending apparatus and the color sensor for synchronizing operation of the bending apparatus and the color sensor and for recording the optical states detected by the color sensor.

2. The system of claim 1, wherein the color sensor comprises a colorimeter, a spectrophotometer, a photoelectric detector, a charge-coupled device (CCD) camera, or a photodiode.

3. The system of claim 1, wherein the bending apparatus comprises a cylinder on which the display sample is held, a fork comprising two prongs positioned in parallel to the cylinder on opposite sides of the cylinder and on an opposite side of the display sample from the cylinder, and a mechanism for moving the cylinder or the fork relative to each other such that the cylinder forms a fulcrum about which the display sample is bent.

4. The system of claim 3, wherein the mechanism for moving the cylinder or the fork comprises a linear actuator.

5. The system of claim 4, wherein the cylinder is stationary and the fork is moved by the linear actuator.

6. The system of claim 5, wherein the linear actuator can be configured to adjust the speed and/or travel distance of the fork.

7. The system of claim 3, wherein the mechanism for moving the cylinder or the fork is operable at an adjustable speed.

8. The system of claim 4, wherein the linear actuator includes a stepper motor.

9. The system of claim 3, wherein the cylinder has a diameter of about 4 mm to 12 mm.

10. The system of claim 3, wherein the cylinder is removably attached in the bending apparatus and is replaceable by another cylinder having a different diameter to adjust a bending curvature of the display sample.

11. The system of claim 3, wherein the cylinder or the fork are moved relative to each other at a speed of 15 cm/sec or less.

12. The system of claim 4, wherein the control system includes a single-axis motion controller for controlling operation of the linear actuator.

13. The system of claim 1, wherein the control system analyzes the optical states detected by the color sensor to quantify optical contrast between the optical states detected at the flat and bent positions in each bending cycle.

14. A method for testing optical states of a piezoelectric-activated electrophoretic display sample comprising an electrophoretic layer superposed on and electrically connected to a piezoelectric layer, wherein the electrophoretic layer is configured to change optical states when the display sample including the piezoelectric layer is manipulated between flat and bent positions to cause the piezoelectric layer to generate an electrical output applied to the electrophoretic layer, the method comprising:
(a) manipulating the display sample between the flat and bent positions using a bending apparatus to mimic hand manipulation of the display sample in a plurality of bending cycles;
(b) detecting the optical state of a given portion of the electrophoretic layer of the display sample when in the flat and bent positions in each bending cycle using a color sensor; and
(c) recording the optical states detected by the color sensor.

15. The method of claim 14, further comprising analyzing the optical states detected by the color sensor to quantify optical contrast between the optical states detected at the flat and bent positions in each bending cycle.

16. The method of claim 14, wherein the color sensor comprises a colorimeter, a spectrophotometer, a photoelectric detector, a charge-coupled device (CCD) camera, or a photodiode.

17. The method of claim 14, wherein the bending apparatus includes a cylinder on which the display sample is held and a fork comprising two prongs positioned in parallel to the cylinder on opposite sides of the cylinder and on an opposite side of the display sample from the cylinder, and wherein step (a) comprises moving the cylinder or the fork relative to each other such that the cylinder forms a fulcrum about which the display sample is bent.

18. The method of claim 17, wherein step (a) comprises moving the fork relative to the cylinder.

19. The method of claim 17, wherein step (a) comprises moving the cylinder relative to the fork.

20. A system, comprising:
a piezoelectric-activated electrophoretic display sample comprising an electrophoretic layer superposed on and electrically connected to a piezoelectric layer, wherein the electrophoretic layer is configured to change optical states when the display sample including the piezoelectric layer is manipulated between flat and bent positions to cause the piezoelectric layer to generate an electrical output applied to the electrophoretic layer;
a bending apparatus for holding and manipulating the display sample between the flat and bent positions to mimic hand manipulation of the display sample in a plurality of bending cycles;
a color sensor operating cooperatively with the bending apparatus to detect the optical state of a given portion of the electrophoretic layer of the display sample in the flat and bent positions in each bending cycle; and
a control system, including at least one processor, coupled to the bending apparatus and the color sensor for synchronizing operation of the bending apparatus and the color sensor and for recording the optical states detected by the color sensor.
